(19) United States
(12) Patent Application Publication
(10) Pub. No.: US 2023/0302427 A1
(43) Pub. Date: Sep. 28, 2023

(54) PRESSED SILICON CARBIDE (SIC) MULTILAYER FLUIDIC MODULES

(71) Applicant: CORNING INCORPORATED, CORNING, NY (US)

(72) Inventors: Alexander Lee Cuno, Sayre, PA (US); Howen Lim, Great Neck, NY (US); James Scott Sutherland, Painted Post, NY (US); Oscar Walter Wheeler, Rochester, NY (US)

(21) Appl. No.: 18/020,783

(22) PCT Filed: Jun. 24, 2021
(86) PCT No.: PCT/US2021/038843

§ 371 Date: Feb. 10, 2023

Related U.S. Application Data
(60) Provisional application No. 63/065,079, filed on Aug. 13, 2020.

(51) Int. Cl. B01J 19/24; B01J 19/00; C04B 35/575; C04B 35/628; C04B 35/645; C04B 38/06; C04B 38/00; B28B 7/34; B28B 3/02

(52) U.S. Cl. CPC B01J 19/2485; B01J 19/0013; C04B 35/575; C04B 35/62802; C04B 35/645; C04B 38/0615; C04B 38/0003; B28B 7/342; B28B 3/02; B01J 2219/2438; B01J 2219/2446; B01J 2219/2445; B01J 2219/2443; B01J 2219/00096; C04B 2235/3826; C04B 2235/6026; C04B 2235/6028; C04B 2235/945; C04B 2235/9607

(57) ABSTRACT

A silicon carbide flow reactor fluidic module comprises a monolithic closed-porosity silicon carbide body and a tortuous fluid passage extending through the silicon carbide body, the tortuous fluid passage lying within two or more layers with the silicon carbide body, the tortuous passage having an interior surface, the interior surface having a surface roughness of less than 10 μm Ra. A method of forming the fluidic module is also disclosed.

### CROSS-REFERENCE TO RELATED APPLICATIONS

This application claims the benefit of priority under 35 U.S.C. § 119 of U.S. Provisional Application No. 63/065,079, filed Aug. 13, 2020, the disclosure of which is incorporated herein by reference in its entirety.

### FIELD

The disclosure relates to methods of demolding powder pressed ceramic structures having internal cavities such as channels and chambers and the like, and more particularly to apparatuses and processes for removing internal molds from green state powder-pressed ceramic structures having internal cavities while preserving the integrity of the powder-pressed structure.

### BACKGROUND

Ceramics generally, and silicon carbide ceramic (SiC) in particular, can be desirable material for fluidic modules for flow chemistry production and/or laboratory work. Some ceramics, and SiC in particular, has relatively high thermal conductivity, useful in performing and controlling endothermic or exothermic reactions. Many ceramics have good physical durability and thermal shock resistance, and good chemical resistance. SiC in particular performs very well on these measures. But these properties, combined with high hardness and abrasiveness, make the practical production of fine or complex structures difficult, in particular the production of internal cavities such as channels or chambers and the like.

One of more of the present inventors and/or their colleagues have previously developed a powder pressing process for producing ceramic structures having internal cavities by pressing a binder-coated ceramic powder with a removeable mold—such as a mold formed of a relatively low temperature melting solid—positioned inside. After pressing, the mold is removed by heating, then the green state ceramic structure is debinded and sintered to form a final densified ceramic structure with the desired internal cavity(ies).

### SUMMARY

One or more of the present inventors has found that the previously developed powder pressing process can be dependent upon variations in in commercially available powder and binder mixtures. Some coater SiC powder products can work well, while in others, the pressed green state structure did not maintain structural integrity to the degree desirable during removal of the mold. Sometimes variations in performance may be present from batch to batch of the same powder product, not just from product to product. In an aspect of the problem, small cracks can be generated in the walls of the cavities of the powder pressed body during heating and removal of the mold material.

Recognizing the desirably to make the process independent of the quality of commercially available ceramic powder/binder mixtures, the present inventors have developed processes according to the present disclosure, according to which a method of removing an internal mold from within a green state powder pressed ceramic body includes applying energy to an internal mold the body to melt a material of the mold while applying a fluid pressure through a flexible membrane to at least two opposite external surfaces of the green state powder pressed ceramic body.

Also disclosed is an apparatus for removing an internal mold from within a green state powder pressed ceramic body includes an openable and closeable frame with an interior, one or more flexible membranes positioned within the frame having a first surface facing the interior and a second surface opposite the first forming at least part of an enclosed volume connected or to be connected to a supply of pressurized fluid, and a pathway through which a melted mold material can drain from the body.

By use of the method and/or the apparatus disclosed, a green state powder pressed ceramic body with internal cavities produced by an internal mold can be demolded by melting the material of the mold without producing or significantly producing interior surface cracks within the cavity.

Additional features and advantages will be set forth in the detailed description which follows, and will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the disclosure and the appended claims.

The accompanying drawings are included to provide a further understanding of principles of the disclosure, and are incorporated in, and constitute a part of, this specification. The drawings illustrate one or more embodiment(s) and, together with the description, serve to explain, by way of example, principles and operation of the disclosure. It is to be understood that various features of the disclosure disclosed in this specification and in the drawings can be used in any and all combinations. By way of non-limiting examples, the various features of the disclosure may be combined with one another according to the following embodiments.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

In the drawings:

FIG. 1 is a diagrammatic perspective view of an embodiment of a mold or molds removeable by melting useful in aspects of the present disclosure;

FIG. 2 is a is a diagrammatic perspective view another embodiment of a mold or molds removeable by melting useful in aspects of the present disclosure;

FIG. 3 is a flow chart reflecting some elements of some embodiments of a method for producing a ceramic structure with internal cavities;

FIG. 4 is a step-wise series of cross-sectional representations of some embodiments of aspects of the method(s) of FIG. 3;

FIG. 5 is a is a diagrammatic plan view in outline of an embodiment of passage shape desirable to use within a ceramic structure as part of a fluidic passage in a flow reactor fluidic module;

FIG. 6 is a diagrammatic cross-sectional view of an embodiment of a ceramic structure with an internal passage or cavity, formed or formable by the method(s) of FIGS. 3 and 4;

FIG. 7 is a perspective external view of an embodiment of a ceramic structure with internal passages or cavities (not visible) in the form of fluid channels or passages and chambers such as those represented in FIGS. 5 and/or 6;

FIG. 8 is a graph illustrating compression release curves useful in practicing the methods of the present disclosure;

FIGS. 9A-9E are cross-section representations of various embodiments of via molds useful in the methods of FIGS. 3 and 4;

FIGS. 10A-10E are cross-section representations of various additional embodiments of via molds useful in the methods of FIGS. 3 and 4; and

FIGS. 11A-11E are cross-section representations of yet more various additional embodiments of via molds useful in the methods of FIGS. 3 and 4.

### DETAILED DESCRIPTION OF THE PREFERRED EMBODIMENTS

Additional features and advantages will be set forth in the detailed description which follows and will be apparent to those skilled in the art from the description, or recognized by practicing the embodiments as described in the following description, together with the claims and appended drawings.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components directly or indirectly to one another. Such joining may be stationary in nature or movable in nature. Such joining may be achieved with the two components and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Directional terms as used herein—for example up, down, right, left, front, back, top, bottom—are made only with reference to the figures as drawn and are not intended to imply absolute orientation.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

As used herein, a “tortuous” passage refers to a passage having no line of sight directly through the passage and with the central path of the passage tracing more than one radius of curvature. Typical machining-based forming techniques are generally inadequate to form such a passage.

As used herein a “monolithic” ceramic or silicon carbide ceramic structure of course does not imply zero inhomogeneities in the ceramic structure at all scales. Monolithic, as the term is defined herein, refers to a ceramic or silicon carbide structure, with a internal cavities such as a tortuous passage extending therethrough, in which no inhomogeneities of the ceramic structure are present of sufficient size to extend from an external surface of the fluidic module to a surface of the tortuous passage.

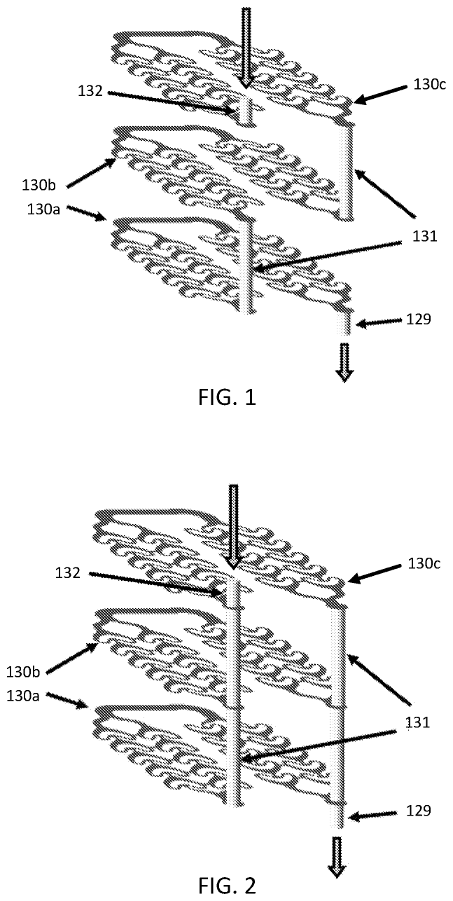

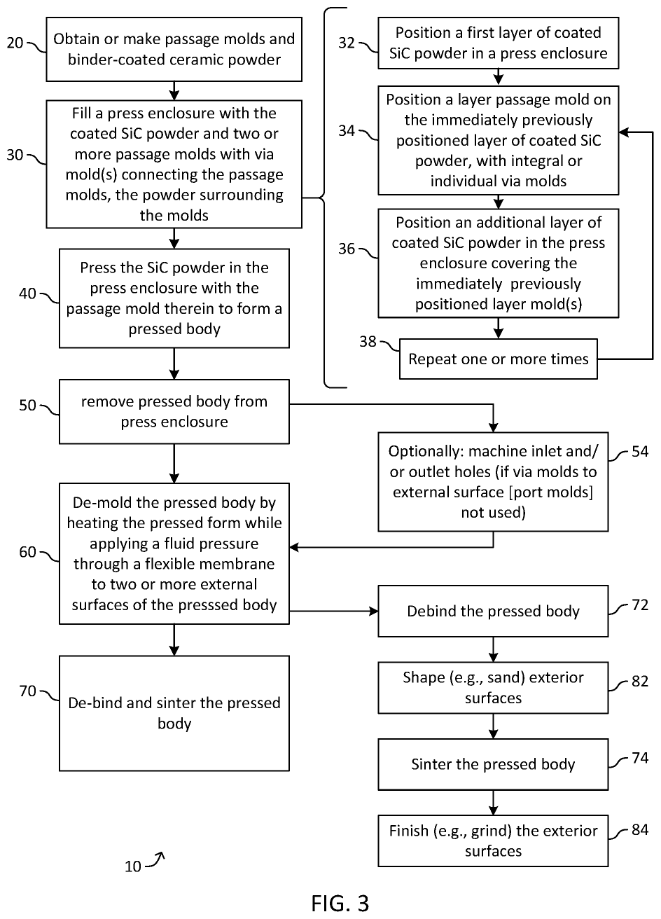

With reference to FIGS. 1-3, a ceramic structure desirably in the form flow reactor module 300, such as a silicon carbide flow reactor fluidic module, is disclosed. The module 300 comprises a monolithic closed-porosity body 200 and a tortuous fluid passage P extending through the body 200, in this example, from input ports IP (IP1, IP2) to output port OP. The tortuous fluid passage P has an interior surface 210. For silicon carbide embodiments, the interior surface 210 desirably has a surface roughness in the range of from 0.1 to 80 μm Ra, or 0.1 to 50, 0.1 to 40, 0.1 to 30, 0.1 to 20, 0.1 to 10, 0.1 to 5, or even 0.1 to 1 μm Ra, lower than silicon carbide fluidic modules have previously been able to achieve.

According to further aspects for silicon carbide embodiments, the body 200 of the fluidic module 300 has a density of at least 95% of a theoretical maximum density of silicon carbide, or even of at least 96, 97, 98, or 99% of theoretical maximum density.

According to further aspects of silicon carbide embodiments, the body 200 of the fluidic module 300 has an open porosity of less than 1%, or even of less than 0.5%, 0.4%, 0.2% or 0.1%.

According to still further aspects of embodiments, the body 200 of the module 300 has an internal pressure resistance under pressurized water testing of at least 50 Bar, or even at least 100 Bar, or 150 Bar.

The tortuous fluid passage P, according to embodiments, comprises a floor 212 and a ceiling 214 separated by a height h and two opposing sidewalls 216 joining the floor 212 and the ceiling 214. The sidewalls are separated by a width w (FIG. 1) measured perpendicular to the height h and the direction along the passage (corresponding to the predominant flow direction when in use). Further, width w is measured at a position corresponding to one-half of the height h. According to embodiments, the height h of the tortuous fluid passage is in the range of from 0.1 to 20 mm, or from 0.2 to 15, or 0.3 to 12 mm.

According to embodiments, the interior surface 210 of the fluidic passage P where the sidewalls 216 meet the floor 212 has a radius of curvature (such as at location 218) of greater than or equal to 0.1 mm, or greater than or equal to 0.3, or even 0.6 mm.

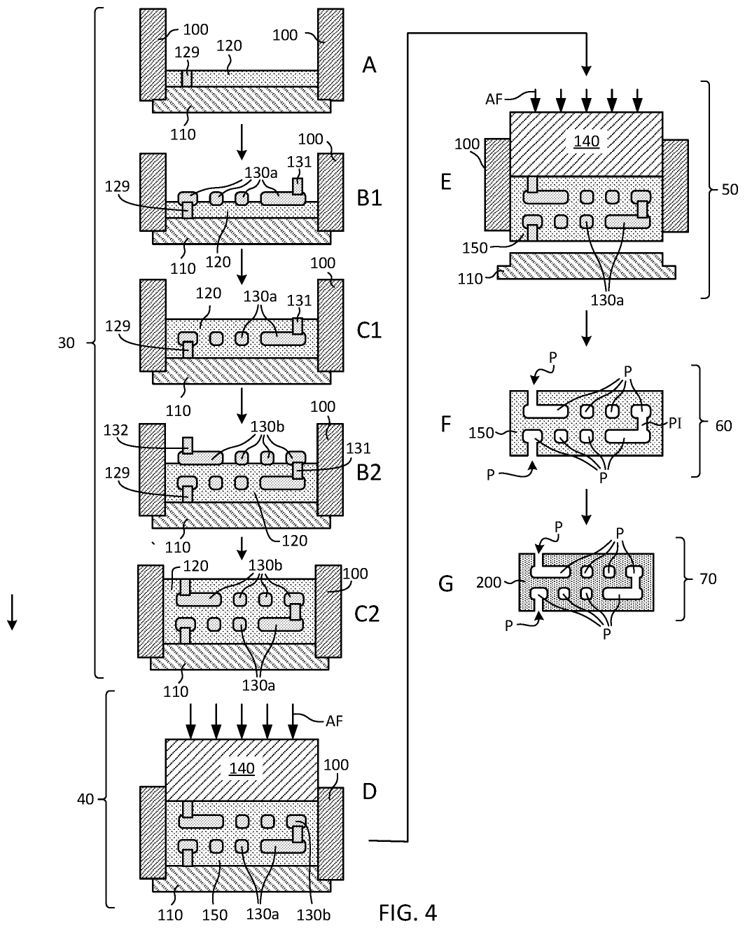

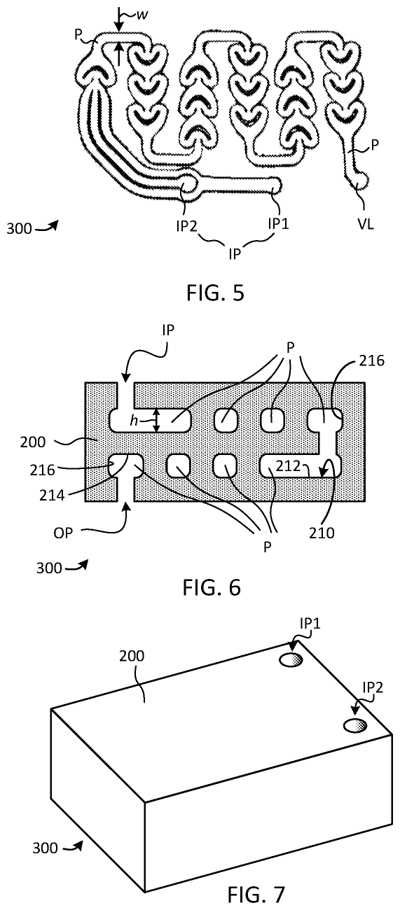

With reference to FIGS. 4 and 5, according to embodiments, a process 10 for forming a ceramic structure, such as a silicon carbide ceramic structure, having one or more of these or other desirable properties can include the step 20 of obtaining or making a passage mold and a binder-coated ceramic powder (such powders are commercially available from various suppliers). The passage mold may be obtained by molding, machining, 3D printing, or other suitable forming techniques or combinations thereof. The material of the passage mold is desirably a relatively incompressible material. The material of the passage mold can be a thermoplastic material.

The process further can include the step of (partially) filling a press enclosure (or die) 100, the press enclosure 100 being closed with a plug 110, with binder-coated ceramic powder 120, as described in step 30 of FIG. 4 and as represented in the cross section of FIG. 5A. Next, the passage mold 130 is placed on/in the ceramic powder 120 (FIG. 5B) and an additional amount of powder is put on top of the mold 130, such that the powder 120 surrounds the mold 130 (FIG. 5C, step 30 of FIG. 4). Next, a piston 140 is inserted in the press enclosure 100 and a force AF is applied to press (compress) the powder 120 with the mold 130 inside (FIG. 5D and FIG. 4 step 40) to form a pressed body 150. (Resistance to the force AF (not shown) is present or supplied at the plug 110 during this step.) Next, with plug 110 now allowed to move, the pressed body 150 is removed by a (smaller) force AF applied to the piston 140 (FIG. 5E, step 50 of FIG. 4).

Next, the pressed body 150, now free from the press enclosure 100, is machined in selected locations, such as by drilling, to form holes or fluidic ports 160 extending from the outside of the pressed body 150 to the mold 130 (FIG. 5F, step 54 of FIG. 4).

Next, the pressed body 150 is demolded by being heated, preferably at a relatively high rate, such that the mold 130 is melted and removed from the pressed body 150 by flowing out of the pressed body 150, and/or by being blown and/or sucked out in addition. (FIG. 5G, step 60 of FIG. 4). The heating may be under partial vacuum, if desired. The heating is performed while applying a fluid pressure through a flexible membrane to two or more external surfaces of the pressed body 150.

After the mold 130 has been melted and removed from the internal cavities or channels in the pressed body 150, the pressed body 150 is then fired (sintered) to densify and further solidify the pressed body into a monolithic silicon carbide body 200. (FIG. 5H, step 70 of FIG. 4).

As shown in the flowchart of FIG. 4, some additional or alternative steps can include step 72, debinding the pressed body prior to sintering (rather than as a unified step, or also rather than as two back-to-back steps), step 82, shaping or preliminarily shaping the exterior surface(s), such as by sanding or other machining before sintering, step 74, sintering the pressed body separately from debinding (and after step 82 shaping or preliminarily shaping), and step 84, finishing the exterior surface(s), such as by grinding, after sintering.

FIG. 6 is a graph illustrating compression release curves useful in practicing the methods of the present disclosure, in particular, showing a desirable relationship between the compression release property of the ceramic powder 120 and the material of the passage mold 130. Specifically, a compression release curve 170 of the ceramic powder material, graphed in units of distance (x axis) vs force (y axis) (arbitrary units shown) (time evolution is downward and leftward) should preferably lie above a compression release curve 180 of the material of the passage mold 130. The respective compression curves, not shown, are not particularly significant. But using a relatively incompressible mold material, such that the ceramic powder compression release curve 170 lies above the mold material compression release curve 180 helps maintain the structural integrity of the pressed body during release of the pressed body from the press enclosure and during other steps subsequent to pressing. Further, to achieve the smooth internal passage walls, ceramic powder with generally smaller particle sizes is preferred, as are passage mold materials having generally higher hardness.

FIG. 7 shows in a cross-sectional representation an embodiment of an apparatus 400 for performing the demolding step 60 of FIG. 4. The apparatus 400 comprises an openable and closeable frame 250, such as with a lid 252 or other means of opening and closing, and with an interior and exterior. One or more flexible membranes 262, 264, 266, 268 are positioned within the frame 250 and have a first surface facing the interior of the frame 250 and a second surface (directly) opposite the first surface, the second surface forming at least part of an enclosed volume having fluid lines, connections, ports, or the like, connected or to be connected to a supply of pressurized fluid F. The apparatus 400 also includes a clearance or a pathway or a port or conduit 282, 284 or the like through which the material of a mold 130 can drain when melted from the from a green state powder pressed ceramic body 150 while a pressure is applied to the green state powder pressed ceramic body 150 by a fluid, through the one or more flexible membranes 262, 264, 266, 268. The fluid supplied by fluid source F can be, according to embodiments, a heated liquid which supplies energy to the mold material by heating the green state powder pressed ceramic body 150.

In alternative embodiments, the fluid source F may supplied gas under pressure such as compressed air or nitrogen, and the apparatus 400 can also include one or more flexible heating pads 272, 274, 276, 278 positioned on the first surface of the one or more flexible membranes 262, 264, 266, 268. A flexible heating pad of the apparatus can comprise (1) multiple zones in which input energy can be individually controlled and/or (2) multiple individually energizeable smaller heating pads, not shown, to which energy can be supplied by a source E of electrical energy.

In operation, in the apparatus of FIG. 7 or similar embodiments, energy is applied to the internal mold 130 within the green state powder pressed ceramic body 150 to melt a material of the internal mold while a fluid pressure is applied through one or more flexible membranes to at least two opposite external surfaces (to the two largest surfaces) of the green state powder pressed ceramic body 150, while one or more of (1) allowing the melted mold material to drain from green state powder pressed ceramic body, (2) blowing the melted mold material from green state powder pressed ceramic body, and (3) sucking the melted mold material from green state powder pressed ceramic body to remove the mold. Energy can be applied to the internal mold by heating the mold by heating the green state powder pressed ceramic body. If pressure is applied to every side of the green state powder pressed ceramic body, such as by having individual flexible membranes on every side, pressure that is essentially isostatic may be applied.

According to additional aspects of the present invention, the flexible membrane through which pressure is applied may take the form of a fluid-tight bag enclosing the green state powder pressed ceramic body.

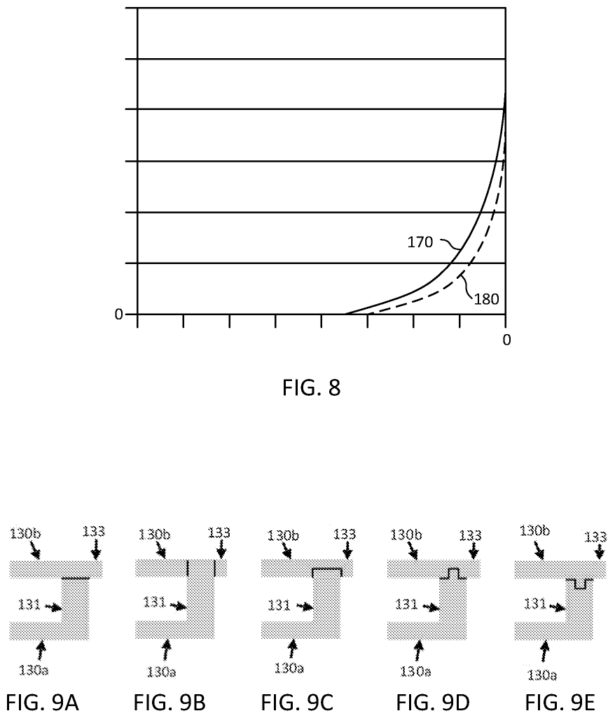

Process steps for one embodiment of demolding green pressed fluidic modules according to this aspect are shown in the flow chart of FIG. 8, and a cross-sectional representation of an apparatus for use in performing the process is shown in FIG. 9. With reference to both figures, the process 500 includes step 510 of sealing a green state powder pressed ceramic body 150, with one or more internal passage molds 130 inside, in fluid-tight bag 320. As seen in FIG. 9, the bag 320 can include a top layer 322 and a bottom layer 324 sealed together at a seal region 326, such as by pinching together and heating top and bottom layers 322, 324 formed of polymer. Multiple rows of thermally produced seals can be used in the seal region 326 if desired. Vacuum sealing can be used and is preferred but not required, as successful tests have been performed with and without vacuum sealing. The bag is fluid-tight to the fluid 340 in the chamber 350, for example, water.

Further in FIG. 9, a press chamber 350 holds a fluid which is, in step 512 of the process 500, preheated to a target temperature for melting the mold (for example, to 50° C. for a wax-based mold). In step 514 the bag 320 with the green state powder pressed ceramic body 150 sealed inside is then lowered into the isostatic press chamber fluid 340. Next in step 515, the isostatic press chamber is immediately closed and sealed pressure is applied to the chamber fluid bath (e.g., 125 PSI), producing essentially isostatic pressure on all surfaces of the body 150. In step 516, the pressure and temperature are maintained for a period of time, such as 90 minutes, to melt the material of the passage mold 130.

The passage mold can be a wax-based material. As the green state powder pressed ceramic body 150 is heated by the warm fluid, the passage mold(s) 130 are also heated, and the mold material begins expanding, softening, and melting. The expansion produces an outward force on the interior walls of the passages within the body 150. The outward force is counteracted and/or balanced, at least in part, by the isostatic pressing force, represented by the arrows 330, applied to the exterior surface of the body 150 through the bag 320.

The melted mold material can move into ports such as ports IP1, IP2, IP, OP shown in FIGS. 1 and 2, or into vents or other passages, not shown in FIG. 8, specifically provided therefor. As the mold material continues to heat, its viscosity can be reduced so that it can flow into the small gaps between powder granules of the body 150 in the region around the internal passage(s).

After the time period of step 516 is ended, the pressure inside the chamber 350 is reduced to atmospheric pressure in step 518, the chamber is opened and the bag 320 and body 150 are removed in step 522, and the bag 320 is removed from the body 150 in step 524. During steps 522 and 524, the body is preferably kept sufficiently warm (for example, at 50° C. or greater) to prevent re-solidification of the mold material, until any remaining mold material is completely removed by heating the body 150 in an oven (for example, at 175° C., in air), in step 526.

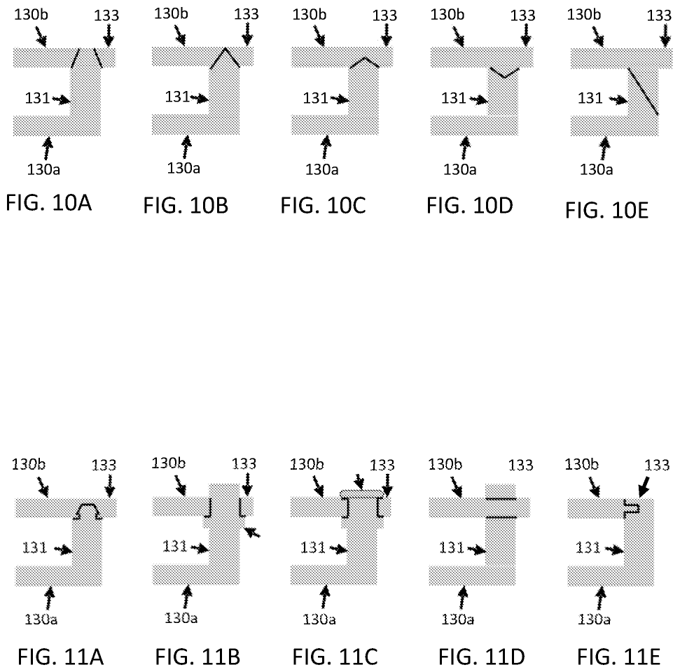

Prior to heating the body 150 in an oven in step 526, the body and the mold material may be in a state general depicted in the cross section of FIG. 9. As shown in FIG. 10, voids 360 may appear due to migration of mold material into ports or vents (not shown) and/or into a region 364 of the body 150 surrounding the internal passages. After the heating of step 526, the mold(s) 130 have been completely removed from the passage(s) P and from the body 150, as shown in the cross section of FIG. 11.

According to another and alternative aspect of the present disclosure shown in the cross section of FIG. 12, force-distribution plates 370 may be positioned between the body 150 and the bag 320. These plates 30, in the form of flexible metal or polymer sheets, for example, 370 can distribute the localized forces of the isostatic pressure across a wider area of the body 150 to prevent any tendency of that pressure to collapse the internal fluid passage(s) as the material of the mold(s) 130 melts. Such plates can be useful, in particular, on surfaces of the body which lie parallel to the larger dimension of the passage(s) 130, as shown in FIG. 12.

The cross section of FIG. 13 depicts additional or alternative features which can be used to assist with removal of melted mold material. As seen in FIG. 13, one or more reservoir frames 380 may be placed against one or more outer surfaces of the body 150. Reservoir frames 380 include a relatively large surface area in contact with the body 150 and reservoirs 382 within the reservoir frames 380. One or more ports or vents 386 for outflow of mold material lead from the internal passage molds 130 to the reservoirs 382. The surface area at which reservoir frames 380 contact the body 150 transfers pressure to the body 150, while the reservoirs 382 receive melted mold material 384 as the mold material softens and flows.

In another additional or alternative aspect, as an alternative to the one or more ports or vents 386 FIG. 14, one or more ridges 388 or “ridge channels” 388 (ridges which form a channel beneath the ridge) may be included one or more of the force distribution plates 370, to allow for flow of melted mold material along the ridge channel 388 to an associated reservoir frame 380. As shown in the figure, the reservoir frames 380 in this aspect can have full contact with the side of the body 150 against which they are positioned, with an opening into the reservoir on an adjoining face of the reservoir frame 380.

In yet another additional or alternative aspect shown in the cross section of FIG. 15, a force distribution plate 390 with cavities 392 can be employed on one or more surfaces of the body 150. The cavities 392 are interconnected (in a plane other than the cross-section shown) and input or output ports IP, OP are aligned with one or more of the cavities 392. Melted mold material from the passage mold(s) 130 can then flow into the cavities 392 as the mold material softens and flows.

In still another additional or alternative aspect shown in the cross section of FIG. 16, one or more tubes 394, can be used, joined at one end to the input or output ports and extending out through the of the chamber 350, with seals 396 maintaining fluid tightness. In this aspect, pressure can be applied (as represented by the arrow at the top of the figure) or vacuum can be applied (as represented by the arrow at the bottom of the figure, or both to assist in the removal of melted mold material.

While exemplary embodiments and examples have been set forth for the purpose of illustration, the foregoing description is not intended in any way to limit the scope of disclosure and appended claims. Accordingly, variations and modifications may be made to the above-described embodiments and examples without departing substantially from the spirit and various principles of the disclosure. All such modifications and variations are intended to be included herein within the scope of this disclosure and protected by the following claims.

1. A silicon carbide flow reactor fluidic module, the module comprising:
a monolithic closed-porosity silicon carbide body; and
a tortuous fluid passage extending through the silicon carbide body, the tortuous fluid passage lying within two or more layers within the silicon carbide body, the tortuous passage having an interior surface;
the interior surface having a surface roughness of less than 10 μm Ra.

2. The fluidic module of claim 1 wherein the surface roughness is in the range of from 0.1 to 5 μm Ra.

3. The fluidic module of claim 1 wherein the surface roughness is in the range of from 0.1 to 1 μm Ra.

4. The fluidic module of claim 1 wherein the silicon carbide of the silicon carbide body has a density of at least 95% of a theoretical maximum density of silicon carbide.

5. The fluidic module of claim 4 wherein the silicon carbide of the silicon carbide body has a density of at least 96% of the theoretical maximum density of silicon carbide.

6. The fluidic module of claim 4 wherein the silicon carbide of the silicon carbide body has a density of at least 97% of the theoretical maximum density of silicon carbide.

7. The fluidic module of claim 4 wherein the silicon carbide of the silicon carbide body has a density of at least 98% of the theoretical maximum density of silicon carbide.

8. (canceled)

9. The fluidic module of claim 4 wherein the fluidic module has an open porosity of less than 1%.

10. The fluidic module of claim 4 wherein the fluidic module has an open porosity of less than 0.5%.

11. The fluidic module of claim 4 wherein the fluidic module has an open porosity of less than 0.1%.

12. The fluidic module of claim 1 wherein an internal pressure resistance of the fluidic module under pressurized water testing is at least 50 Bar.

13. The fluidic module of claim 1 wherein an internal pressure resistance of the fluidic module under pressurized water testing is at least 100 Bar.

14. The fluidic module of claim 1 wherein an internal pressure resistance of the fluidic module under pressurized water testing is at least 150 Bar.

15. The fluidic module of claim 1 wherein the interior surface of tortuous fluid passage comprises a floor and a ceiling separated by a height h and two opposing sidewalls joining the floor and the ceiling, the sidewalls separated by a width w measured perpendicular to the height h and at a position corresponding to one-half of the height h wherein the height h of the tortuous fluid passage is in the range of from 0.1 to 20 mm.

16. The fluidic module of claim 15 wherein the height h of the tortuous fluid passage is in the range of from 0.2 to 15 mm.

17. The fluidic module of claim 15 wherein the height h of the tortuous fluid passage is in the range of from 0.3 to 12 mm.

18. The fluidic module of claim 15 wherein the interior surface where the sidewalls meet the floor has a radius of curvature in the range of 0.1 to 3 mm.

19. The fluidic module of claim 15 wherein the interior surface where the sidewalls meet the floor has a radius of curvature in the range of from 0.3 mm to 2 mm.

20. The fluidic module of claim 15 wherein the interior surface where the sidewalls meet the floor has a radius of curvature in the range of from 0.6 mm to 1 mm.

21. A process for forming a silicon carbide fluidic module for a flow reactor, the process comprising:
positioning a first layer of silicon carbide powder, the powder coated with a binder;
positioning a first positive fluid passage mold having a tortuous shape on the first layer of silicon carbide powder;
covering the first positive fluid passage mold with a second layer of silicon carbide powder;
positioning a second positive fluid passage mold having a tortuous shape on the second layer of silicon carbide powder, the covering of the first positive fluid passage mold covering all of the mold structure with the second layer of the second silicon carbide powder except for one or more via molds, the second positive fluid passage mold contacting the one or more via molds when positioned on the second layer of silicon carbide powder;
covering the second positive fluid passage mold with a third layer of silicon carbide powder except at the positions of via molds and an input port mold or an exit port mold, or multiple of either, if any;
pressing the layers of silicon carbide powder with the molds inside to form a pressed body;
heating the pressed body to remove the mold; and
sintering the pressed body to form a monolithic silicon carbide fluidic module having a tortuous fluid passage extending therethrough, the tortuous passage lying within two or more layers within the monolithic silicon carbide fluidic module.
